(19) United States
(12) Patent Application Publication
(10) Pub. No.: US 2026/0156724 A1
(43) Pub. Date: Jun. 4, 2026

(54) HANDHELD INDUCTION HEATER

(71) Applicant: Guangdong DuroPower Industries Limited, Huizhou (CN)

(72) Inventor: Youlei Yin, Huizhou (CN)

(21) Appl. No.: 19/261,633

(22) Filed: Jul. 7, 2025

(51) Int. Cl. H05B 6/36

(52) U.S. Cl. CPC H05B 6/36

(57) ABSTRACT

The invention discloses a handheld induction heater, aiming to solve the problem in the prior art where the induction heating coil cannot be easily disassembled and reassembled due to the absence of tools. The handheld induction heater comprises a heater body, a heat sink installed inside the front end of the heater body, a mounting hole opened inside the heat sink, and an elastic pin slidably installed inside the heat sink, wherein a housing is installed at one end of the heater body, and an induction heating coil can be squeezed and fixed through a limit component.

### TECHNICAL FIELD

The invention belongs to the technical field of electromagnetic heating, and in particular relates to a handheld induction heater.

### BACKGROUND ART

In existing electromagnetic induction heaters, the induction heating coils are secured by tightening screws. The specific operation process is as follows: the heat sink is installed inside the heater body, and the mounting hole for inserting the connecting end of the heating coil is opened inside the heat sink; after inserting the connecting end of the heating coil into the mounting hole, turn the screw at the connecting end of the coil to press against the induction heating coil, thereby securing the induction heating coil; to remove the induction heating coil, turn the screw in the opposite direction. This method requires tools such as a screwdriver for both installation and removal, making assembly or disassembly impossible without the necessary tools.

### SUMMARY OF THE INVENTION

### (1) Technical problems to be solved

In terms of the deficiencies of the prior art, the invention aims to provide a handheld induction heater, aiming to solve the problem in the prior art that the induction heating coil cannot be easily disassembled and reassembled due to the absence of appropriate tools.

### (2) Technical proposal

To solve the abovementioned technical problems, the invention provides a handheld induction heater comprising a heater body, a heat sink installed inside the front end of the heater body, a mounting hole provided inside the heat sink, and an elastic pin slidably installed inside the heat sink, wherein a housing sleeved outside the heat sink is arranged at one end of the heater body, a limit component is arranged between the housing and the heat sink, and an induction heating coil can be squeezed and fixed through the limit component.

Preferably, a pin hole matched with the elastic pin is opened inside the heat sink and connected to the mounting hole.

Further, the limit component comprises a shell slidably installed on the housing and an arched sheet fixedly installed on the inner wall of the shell, the housing is integrally formed with the heater body, and a straight slot is provided on the housing to allow the arched sheet to slide.

Still further, a ring-shaped sliding block is fixedly installed on the inner wall of the shell, a ring-shaped sliding groove matched with the ring-shaped sliding block is arranged on the outer surface of the housing, and the shell is slidably installed on the housing through the fit between the ring-shaped sliding block and the ring-shaped sliding groove.

Still further, the arched sheet features a T-shaped structure, a first mounting groove for installing the arched sheet is arranged on the surface of the annular sliding block, a first mounting rail for the two ends of the arched sheet to enter is arranged on both sides of the first mounting groove, and the first mounting groove is also provided with a first limit groove for limiting the tail end of the arched sheet.

Still further, at least one groove is arranged on the outer surface of the shell.

Still further, the housing is integrally formed with the heater body, a sliding groove is opened on the housing, the limit component comprises a sliding block slidably installed inside the sliding groove, a sliding plate fixedly installed with the sliding block, and an arched sheet fixedly installed on the side of the sliding plate far from the sliding block.

Still further, the sliding plate is slidably installed inside the housing.

Still further, the arched sheet features a T-shaped structure, a second mounting groove for installing the arched sheet is opened on one side of the sliding plate far from the sliding block, a second mounting rail for the two ends of the arched sheet to enter is arranged on both sides of the second mounting groove, and the second mounting groove is also provided with a second limit groove for limiting the tail end of the arched sheet.

Still further, the elastic pin comprises a pin, a sliding rod fixedly installed on the side of the pin and a spring fixedly installed on the sliding rod, a spring cavity connected to the pin hole is arranged inside the heat sink, the sliding rod is slidably installed inside the spring cavity, and the end of the spring far from the sliding rod is fixedly installed inside the spring cavity.

### (3) Beneficial effects

Compared with the prior art, the invention has the following beneficial effects:

In the assembly and disassembly process described in the invention, the user only needs to use the limit component to secure or release the heating coil. No external tools are required throughout the entire assembly and disassembly process, making the process convenient and efficient. This design enables assembly and disassembly even when tools are not available.

### BRIEF DESCRIPTION OF THE DRAWINGS

FIG. 1 is a three-dimensional schematic diagram of the overall structure in Embodiment 1 of the invention.

FIG. 2 is a three-dimensional schematic diagram of the housing in Embodiment 1 of the invention.

FIG. 3 is a three-dimensional schematic diagram of the shell in Embodiment 1 of the invention.

FIG. 4 is a three-dimensional schematic diagram of the heat sink in Embodiment 1 of the invention.

FIG. 5 is an exploded diagram for the assembly of the arched sheet, the shell and the heat sink in Embodiment 1 of the invention.

FIG. 6 is a sectional view of the housing, shell, and heat sink in Embodiment 1 of the invention.

FIG. 7 is an enlarged view of the structure at point A in FIG. 5 of the invention.

FIG. 8 is an assembly diagram of the arched sheet and the shell in Embodiment 1 of the invention.

FIG. 9 is a three-dimensional schematic diagram of Embodiment 1 in the invention.

FIG. 10 is a three-dimensional schematic diagram of the limit component in Embodiment 1 of the invention.

FIG. 11 is an assembly diagram of the arched sheet and sliding plate in Embodiment 2 of the invention.

Reference signs: 1. Heater body; 2. Heat sink; 3. Mounting hole; 4. Elastic pin; 5. Housing; 6. Limit component; 401. Pin; 402. Sliding rod; 403. Spring; 501. Straight slot; 502. Sliding groove; 601. Shell; 6011. First mounting groove; 6012. First mounting rail; 6013. First limit groove; 602. Arched sheet; 603. Annular sliding groove; 604. Groove; 605. Sliding block; 606. Sliding plate; 6061. Second mounting groove; 6062. Second mounting groove rail; 6063. Second limit groove.

### DETAILED DESCRIPTION OF THE INVENTION

### Embodiment 1

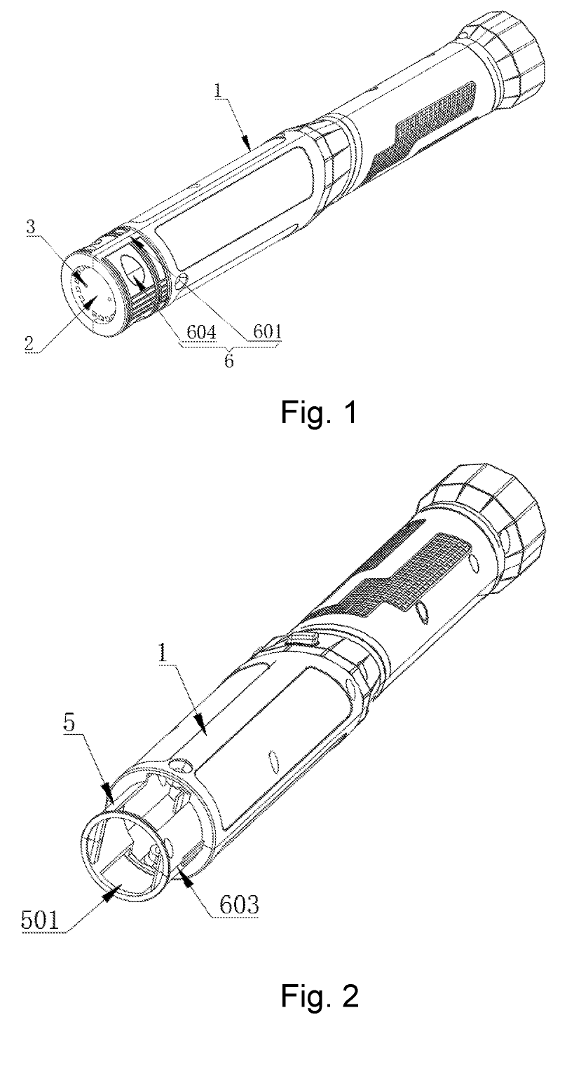

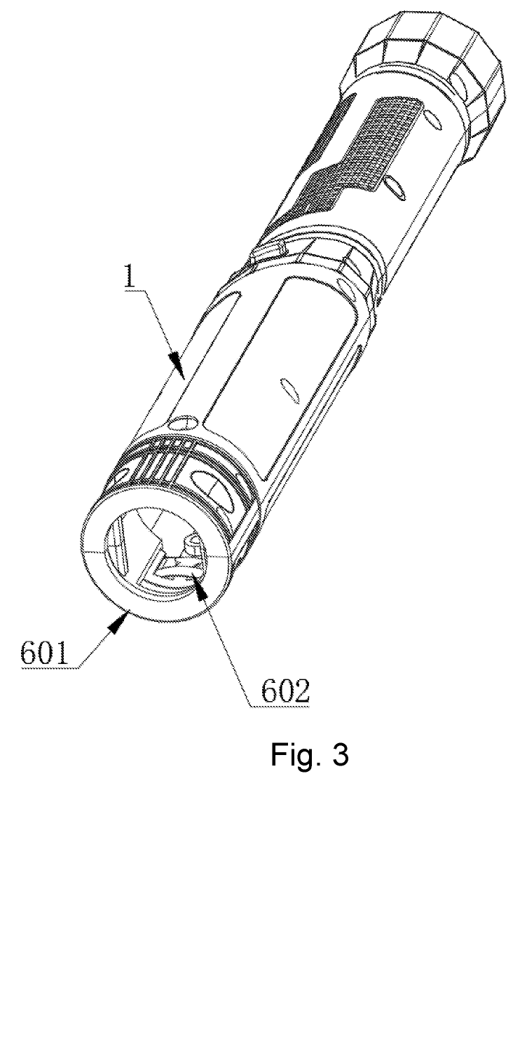

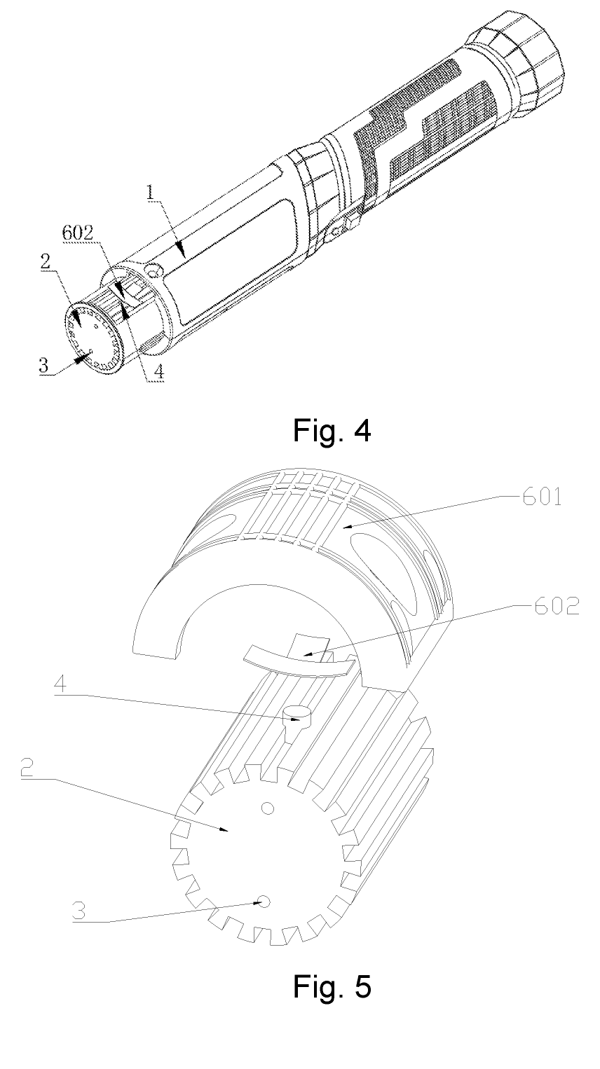

This embodiment is a handheld induction heater, and its structure diagram is shown in FIG. 1 to FIG. 7. The handheld induction heater comprises a heater body (1), a heat sink (2) installed inside the front end of the heater body (1), a mounting hole (3) provided inside the heat sink (2), and an elastic pin (4) slidably installed inside the heat sink (2), wherein a housing (5) sleeved outside the heat sink (2) is arranged at one end of the heater body (1), a limit component (6) is arranged between the housing (5) and the heat sink (2), and an induction heating coil can be squeezed and fixed through the limit component (6).

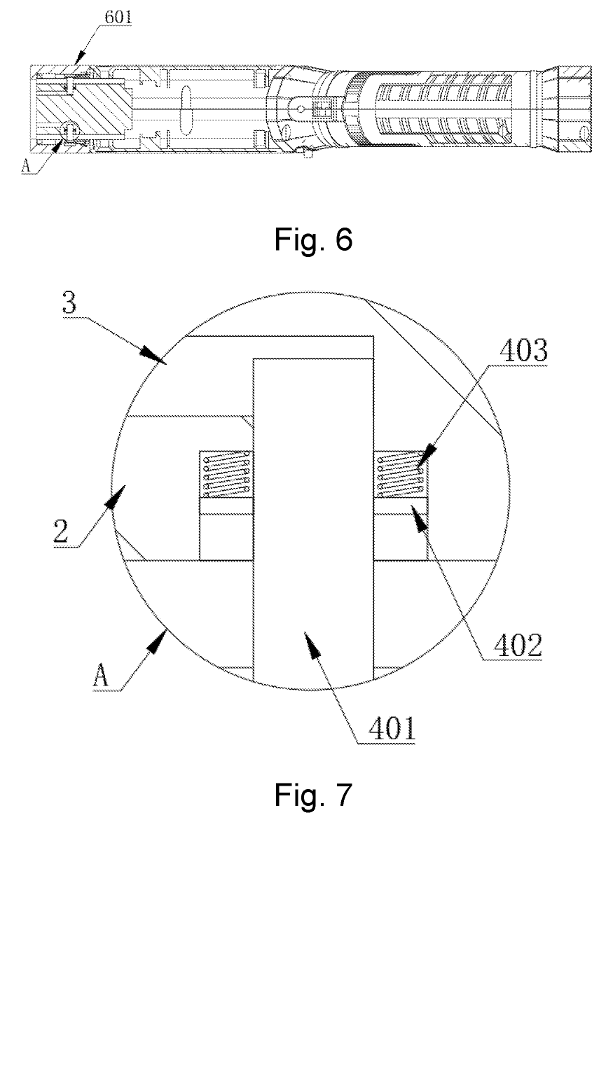

As shown in FIG. 1, FIG. 6 and FIG. 7, a pin hole matched with the elastic pin (4) is opened inside the heat sink (2) and connected to the mounting hole (3), two mounting holes (3), two pinholes, two elastic pins (4), and two limit components (6) are arranged correspondingly, the two limit components (6) respectively squeeze the two elastic pins (4), the two elastic pin holes are respectively connected to the two mounting holes (3), the two elastic pins (4) are slidably installed inside the elastic pin holes, and the two connecting ends of the heating coil are pressed and secured by the two elastic pins (4) when being inserted into the two mounting holes (3);

In Embodiment (1), the limit component (6) comprises a shell (601) slidably installed on the housing and an arched sheet (602) fixedly installed on the inner wall of the shell (601). The housing (5) is integrally formed with the heater body (1), and a straight slot (501) is provided on the housing (5) to allow the arched sheet (602) to slide.

As shown in FIG. 1 to FIG. 6, when the two connection ends of the heating coil are respectively inserted into two mounting holes (3), the shell (601) can drive the arched sheet (602) to move synchronously by sliding the shell (601) towards the heater body (1), the arched sheet (602) is in continuous contact with the elastic pin (4) during the movement, the elastic pin (4) is in initial contact with the very bottom of the arched sheet (602), and the arched sheet (602) continuously squeezes and presses the elastic pin (4) into the interior of the mounting hole (3) from the inside of the pin hole during the sliding process of the arched sheet (602) towards the heater body (1); when the highest point of the arched sheet (602) comes into contact with the elastic pin (4), the elastic pin (4) presses the connection end of the heating coil tightly into the interior of the mounting hole (3); at this point, the fixation of the heating coil is completed;

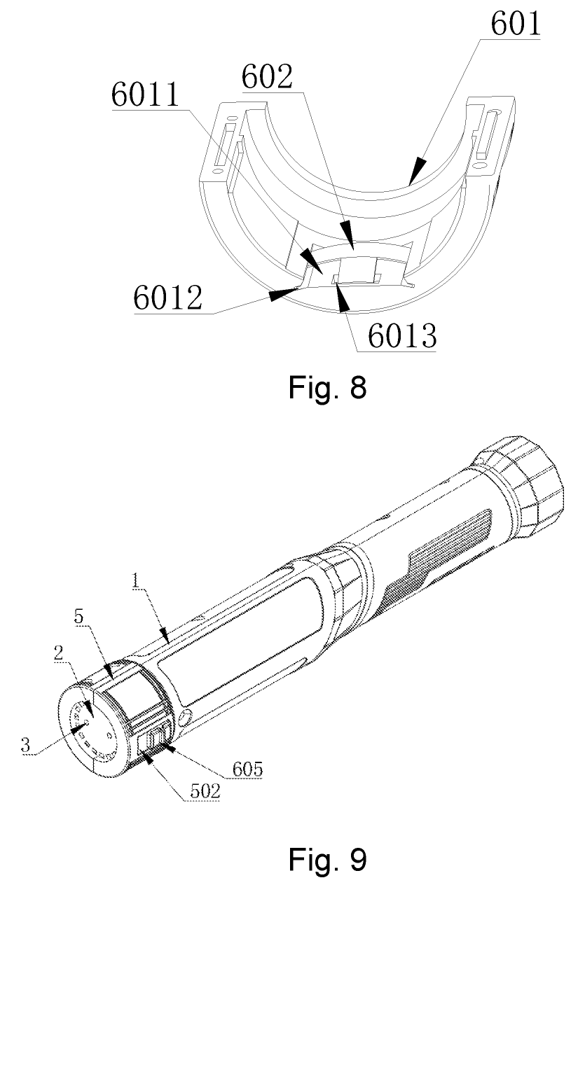

As shown in FIG. 2, FIG. 5, FIG. 6, FIG. 7 and FIG. 8, similarly, the elastic pin (4) initially comes into contact with the highest point of the arched sheet (602) during disassembly, the shell (601) can drive the arched sheet (602) to move synchronously by sliding the shell (601) in the direction away from the heater body (1), and the arched sheet (602) can release the compression on the elastic pin (4) during the movement, so that the fixation of the heating coil by the elastic pin (4) can be relieved;

The entire assembly and disassembly process requires no external tools, allowing for convenient and rapid assembly and disassembly of the heating coil even in the absence of tools.

As shown in FIG. 2, FIG. 5, FIG. 6, FIG. 7 and FIG. 8, a ring-shaped sliding block is fixedly installed on the inner wall of the shell (601), a ring-shaped sliding groove (603) matched with the ring-shaped sliding block is arranged on the outer surface of the housing (5), and the shell (601) is slidably installed on the housing (5) through the fit between the ring-shaped sliding block and the ring-shaped sliding groove (603), which can play a guiding role in the sliding of the shell (601);

As shown in FIG. 1, at least one groove (604) is arranged on the outer surface of the shell (601); under the action of at least one groove (604), the user’s fingers can be accommodated, thus enabling the user to hold the shell (601) for sliding.

In addition, in Embodiment 1, as shown in FIG. 8, the arched sheet (602) features a T-shaped structure, a first mounting groove (6011) for installing the arched sheet (602) is arranged on the surface of the annular sliding block, a first mounting rail (6012) is arranged on both sides of the first mounting groove (6011) for the two ends of the arched sheet (602) to enter, and the first mounting groove (6011) is also provided with a first limit groove (6013) for limiting the tail end of the arched sheet (602).

The first mounting rail (6012) is arranged to facilitate the installation of both sides of the arched sheet (602). When both sides of the arched sheet (602) enter the first mounting groove (6011) along the first mounting rail (6012), the tail end of the arched sheet (602) is clamped in the first limit groove (6013) to achieve the installation of the entire arched sheet (602); when it is necessary to replace the arched sheet (602), just use a tool or manually pull out the tail end of the arched sheet (602) from the first limit groove (6013), and then, pull it out along the arched sheet (602) from the first mounting rail (6012). The entire assembly or disassembly process is very simple and convenient.

As shown in FIG. 7, the elastic pin (4) comprises a pin (401), a sliding rod (402) fixedly installed on the side of the pin (401) and a spring (403) fixedly installed on the sliding rod (402), a spring cavity connected to the pin hole is arranged inside the heat sink (2), the sliding rod (402) is slidably installed inside the spring cavity, and the end of the spring (403) far from the sliding rod (402) is fixedly installed inside the spring cavity.

During installation, as the arched sheet (602) comes into contact with the pin (401) from the bottom until the highest point of the arched sheet (602) comes into contact with the pin (401), and the arched sheet (602) squeezes the pin (401) from the pin hole into the mounting hole (3), the pin (401) synchronously drives the sliding rod (402) to slide inside the spring cavity and squeeze the spring (403);

During disassembly, the arched sheet (602) comes into contact with the pin (401) from the highest point until the bottom of the arched sheet (602) comes into contact with the pin (401), so that the arched sheet (602) no longer squeezes the pin (401). At this time, under the reset effect of the spring (403), the sliding rod (402) is driven to slide and reset inside the spring cavity. During the sliding process, the sliding rod (402) can drive the pin (401) to move synchronously and reset to the interior of the pinhole.

### Embodiment 2

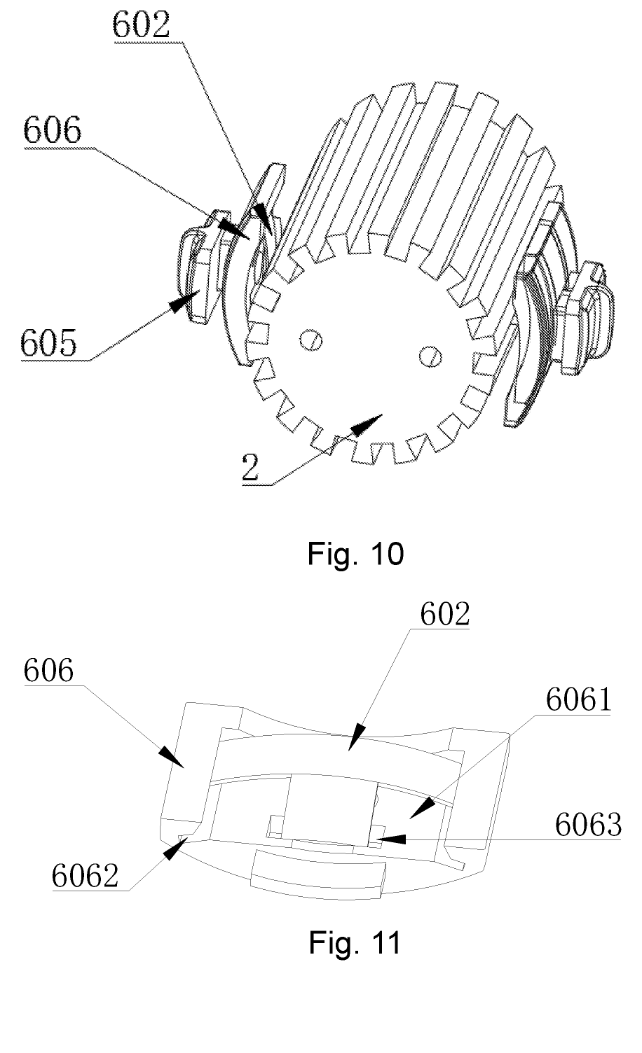

As shown in Fig.9, FIG. 10 and FIG. 11, in the present embodiment, the housing (5) is integrally formed with the heater body (1), a sliding groove (502) is opened on the housing (5), the limit component (6) comprises a sliding block (605) slidably installed inside the sliding groove (502), a sliding plate (606) fixedly installed with the sliding block (605), and an arched sheet fixedly installed on the side of the sliding plate (606) far from the sliding block (605), the sliding plate (606) is slidably installed inside the housing (5), and the two sides of the sliding plate (606) are respectively in contact with the inner wall of the housing (5) and the outer wall of the heat sink (2);

During installation, simply push the sliding block (605) to move inside the sliding groove (502) arranged in the housing (5) towards the direction close to the heater body (1). This action allows the sliding plate (606) to drive the arched sheet (602) to squeeze the pin (401). (In this embodiment, the structure of the heat sink (2) is similar to that of the heat sink (2) in Embodiment 1, so directly refer to FIG. 5 and FIG. 6). Press and fix the connection end of the heating coil inside the mounting hole (3).

Refer to FIG. 9 and FIG. 5 to FIG. 6. During disassembly, simply push the sliding block (605) away from the heater body (1) inside the sliding groove (502) arranged in the housing (5). This action allows the sliding plate (606) to release the arched sheet (602), which in turn stops squeezing the pin (401). Under the reset effect of the spring (403), the pin (401) retracts from the mounting hole (3) into the pinhole. As a result, the connection end of the heating coil is released, allowing the heating coil to be disassembled.

Moreover, as shown in FIG. 10 and FIG. 11, the arched sheet (602) features a T-shaped structure, a second mounting groove (6061) for installing the arched sheet (602) is provided on one side of the sliding plate (606) far from the sliding block (605), a second mounting rail (6062) for the two ends of the arched sheet (602) to enter is arranged on both sides of the second mounting groove (6061), and the second mounting groove (6061) is also provided with a second limit groove (6063) for limiting the tail end of the arched sheet (602).

Similar to Embodiment 1, in Embodiment 2, the second mounting rail (6062) is arranged to facilitate the installation of both sides of the arched sheet (602). As both sides of the arched sheet (602) enter the second mounting groove (6011) along the second mounting rail (6012), the tail end of the arched sheet (602) is clamped in the second limit groove (6013) to achieve the installation of the entire arched sheet (602); when it is necessary to replace the arched sheet (602), just use a tool or manually pull out the tail end of the arched sheet (602) from the second limit groove (6013), and then pull it out along the arched sheet (602) from the second mounting rail (6012). The entire assembly or disassembly process is very simple and convenient.

In the application, the arched sheet (602) can be hard and non-deformable metal sheet, provided that the material meets the use requirements. The improvement points in the application pertain solely to the fixation of the heating coil. The internal structure of the heater body (1), the heat sink (2), and how the heater body (1) achieves the heating of the heating coil are not the improvement points of this application. These aspects are considered prior art and will not be discussed further here.

In summary, the invention allows users to attach and detach the heating coil solely through the limit component (6) during assembly and disassembly. No external tools are required throughout the entire assembly and disassembly process of the heating coil, making it both convenient and efficient. This design enables assembly and disassembly even when tools are not available.

The above embodiments are preferred embodiments of the invention. However, the invention may also be implemented in other ways. Any obvious substitutions, without departing from the concept of the technical proposal, shall fall within the protection scope of the invention.

What is claimed is:

1. A handheld induction heater, characterized by comprising a heater body (1), a heat sink (2) installed inside the front end of the heater body (1), a mounting hole (3) provided inside the heat sink (2), and an elastic pin (4) slidably installed inside the heat sink (2), wherein a housing (5) sleeved outside the heat sink (2) is arranged at one end of the heater body (1), a limit component (6) is arranged between the housing (5) and the heat sink (2), and an induction heating coil can be squeezed and fixed through the limit component (6).

2. The handheld induction heater according to claim 1, characterized in that a pin hole matched with the elastic pin (4) is provided inside the heat sink (2) and connected to the mounting hole (3).

3. The handheld induction heater according to claim 1, characterized in that the limit component (6) comprises a shell (601) slidably installed on the housing and an arched sheet (602) fixedly installed on the inner wall of the shell (601), the housing (5) is integrally formed with the heater body (1), and a straight slot (501) is provided on the housing (5) to allow the arched sheet (602) to slide.

4. The handheld induction heater according to claim 3, characterized in that a ring-shaped sliding block is fixedly installed on the inner wall of the shell (601), a ring-shaped sliding groove (603) matched with the ring-shaped sliding block is arranged on the outer surface of the housing (5), and the shell (601) is slidably installed on the housing (5) through the fit between the ring-shaped sliding block and the ring-shaped sliding groove (603).

5. The handheld induction heater according to claim 4, characterized in that the arched sheet (602) features a T-shaped structure, a first mounting groove (6011) for installing the arched sheet (602) is arranged on the surface of the annular sliding block, a first mounting rail (6012) for the two ends of the arched sheet (602) to enter is arranged on both sides of the first mounting groove (6011), and the first mounting groove (6011) is also provided with a first limit groove (6013) for limiting the tail end of the arched sheet (602).

6. The handheld induction heater according to claim 3, characterized in that at least one groove (604) is arranged on the outer surface of the shell (601).

7. The handheld induction heater according to claim 1, characterized in that the housing (5) is integrally formed with the heater body (1), a sliding groove (502) is opened on the housing (5), the limit component (6) comprises a sliding block (605) slidably installed inside the sliding groove (502), a sliding plate (606) fixedly installed with the sliding block (605), and an arched sheet fixedly installed on the side of the sliding plate (606) far from the sliding block (605).

8. The handheld induction heater according to claim 7, characterized in that the sliding plate (606) is slidably installed inside the housing (5).

9. The handheld induction heater according to claim 7, characterized in that the arched sheet (602) features a T-shaped structure, a second mounting groove (6061) for installing the arched sheet (602) is opened on one side of the sliding plate (606) far from the sliding block (605), a second mounting rail (6062) for the two ends of the arched sheet (602) to enter is arranged on both sides of the second mounting groove (6061), and the second mounting groove (6061) is also provided with a second limit groove (6063) for limiting the tail end of the arched sheet (602).

9. The handheld induction heater according to claim 1, characterized in that the elastic pin (4) comprises a pin (401), a sliding rod (402) fixedly installed on the side of the pin (401) and a spring (403) fixedly installed on the sliding rod (402), a spring cavity connected to the pin hole is arranged inside the heat sink (2), the sliding rod (402) is slidably installed inside the spring cavity, and the end of the spring (403) far from the sliding rod (402) is fixedly installed inside the spring cavity.
